(19) United States
(12) Patent Application Publication
(10) Pub. No.: US 2021/0304094 A1
(43) Pub. Date: Sep. 30, 2021

(54) COMPUTER-IMPLEMENTED SYSTEMS AND METHODS FOR INTELLIGENT PROFIT GAP DETERMINATION AND RESPONSIVE ADJUSTMENT

(71) Applicant: COUPANG CORP., Seoul (KR)

(72) Inventors: Tapan SHAH, Bellevue, WA (US); Bijoy BORDOLOI, Seattle, WA (US); Xiao ZHOU, Seattle, WA (US); Abhy PADIYAR, Seattle, WA (US); Xuelei SUN, Bellevue, WA (US); Young Jin KIM, Gunpo (KR); Jun Young MUN, Seoul (KR)

(73) Assignee: Coupang Corp

(21) Appl. No.: 16/834,021

(22) Filed: Mar. 30, 2020

(51) Int. Cl. G06Q 10/06; G06Q 30/06

(52) U.S. Cl. CPC G06Q 10/0637; G06Q 10/06312; G06Q 10/06315; G06Q 30/0643

(57) ABSTRACT

Disclosed embodiments provide computer-implemented systems and methods for determining a gap to meet a goal for use with a user interface. A method for determining a gap logistics comprises receiving, from a user device, a input, a target, and a request to determine a gap to determine the target based on the input for a set of groups, capturing sales data, price data, and funding data associated with the set of groups from a system, and determining the gap by applying the received input, the received target, the captured sales data, the captured price data, and the received funding data to a predefined formula. The method further comprises providing the determined gap to the user device and transmitting, from the user device, a request to provide a fund to close the determined gap to a computing device of an entity associated with the set of groups.

### TECHNICAL FIELD

The present disclosure generally relates to computerized systems and methods for intelligent profit gap determination and responsive adjustment. In particular, embodiments of the present disclosure relate to inventive and unconventional systems relate to computer-implemented systems, methods, and web-browser plugins for conveniently performing an intelligent profit gap determination for determining a gap to meet a goal for use with a user interface.

### BACKGROUND

A brand manager is responsible for ensuring that products, services, and product lines that fall under his/her domain resonate with current and potential customers. In order to achieve this goal, the brand manager continuously monitors marketing trends and keep a close eye on competitive products in the marketplace. The brand manager utilizes electronic systems providing margins on products that rely on manual work.

For example, conventional electronic systems use equations incorporated in a spreadsheet to calculate margins for products. However, the conventional electronic systems do not conveniently provide the brand manager how much a reduction in a cost price for each product is required for the brand manager to meet his goal. Moreover, the systems do not conveniently provide a gap to the brand managers, wherein the gap may close his goal when the cost price is adjusted.

Therefore, there is a need for improved methods and systems for providing a gap to meet a goal.

### SUMMARY

One aspect of the present disclosure is directed to a computer-implemented system for performing an automated calculation for determining a gap to meet a goal for use with a user interface. The system may comprise one or more memory devices storing instructions and one or more processors configured to execute the instructions to perform operations. The operations may comprise receiving, from a user device, a first input, a target, and a first request to determine a first gap to determine the target based on the input for a first set of groups, capturing first sales data, first price data, and first funding data associated with the first set of groups from a system, and determining the first gap by applying the received first input, the received target, the captured sales data, the captured price data, and the received funding data to a predefined formula. The operations may further comprise providing the determined first gap to the user device and transmitting, from the user device, a first request to provide a first fund to close the determined first gap to a first computing device of a first entity associated with the first set of groups.

Another aspect of the present disclosure is directed to a method for performing an automated calculation for determining a gap to meet a goal for use with a user interface. The method may comprise receiving, from a user device, a first input, a target, and a first request to determine a first gap to determine the target based on the input for a first set of groups, capturing first sales data, first price data, and first funding data associated with the first set of groups from a system, and determining the first gap by applying the received first input, the received target, the captured sales data, the captured price data, and the received funding data to a predefined formula. The method may further comprise providing the determined first gap to the user device and transmitting, from the user device, a first request to provide a first fund to close the determined first gap to a first computing device of a first entity associated with the first set of groups.

Yet another aspect of the present disclosure is directed to a computer-implemented system for performing an automated calculation for determining a gap to meet a goal for use with a user interface. The computer-implemented system may comprise one or more memory devices storing instructions and one or more processors configured to execute the instructions to perform operations. The operations may comprise receiving, from a user device, a first input, a target, and a first request to determine a first gap to determine the target based on the input for a first set of groups, capturing first sales data, first price data, and first funding data associated with the first set of groups from a system, and determining the first gap by applying the received first input, the received target, the captured sales data, the captured price data, and the received funding data to a predefined formula. The operations may further comprise providing the determined first gap and an updated gross profit per unit to the user device and transmitting, from the user device, a first request to provide a first fund to close the determined first gap to a first computing device of a first entity associated with the first set of groups.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3A depicts an exemplary user interface for performing an automated calculation for determining a gap to meet a goal, consistent with the disclosed embodiments.

FIG. 3B depicts an exemplary user interface for performing an automated calculation for determining a gap to meet a goal and displaying the gap for a specified subset of products, consistent with disclosed embodiments.

FIG. 4A is an exemplary flow chart of process for performing an automated calculation for determining a gap to meet a goal for use with a user interface, consistent with the disclosed embodiments.

FIG. 4B is an exemplary flow chart of process 410 for processing a predefined formula to determine a gap, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to computer-implemented systems and methods configured for performing an automated calculation for determining a gap to meet a goal for use with a user interface. The disclosed embodiments provide innovative technical features that enable determining a gap to meet a goal by performing automated calculation by using a user interface. For example, the disclosed embodiments receive an input, a target, and a request to determine a gap to determine the target based on the input for a set of groups, determine the gap by applying the received input, the received target, sales data, price data, and funding data to a predefined formula, and conveniently provide the determined gap to a user requesting the gap. Moreover, the disclosed embodiments may enable the user device to transmit a request to provide funds to close the determined gap to a computing device of an entity associated with the set of groups.

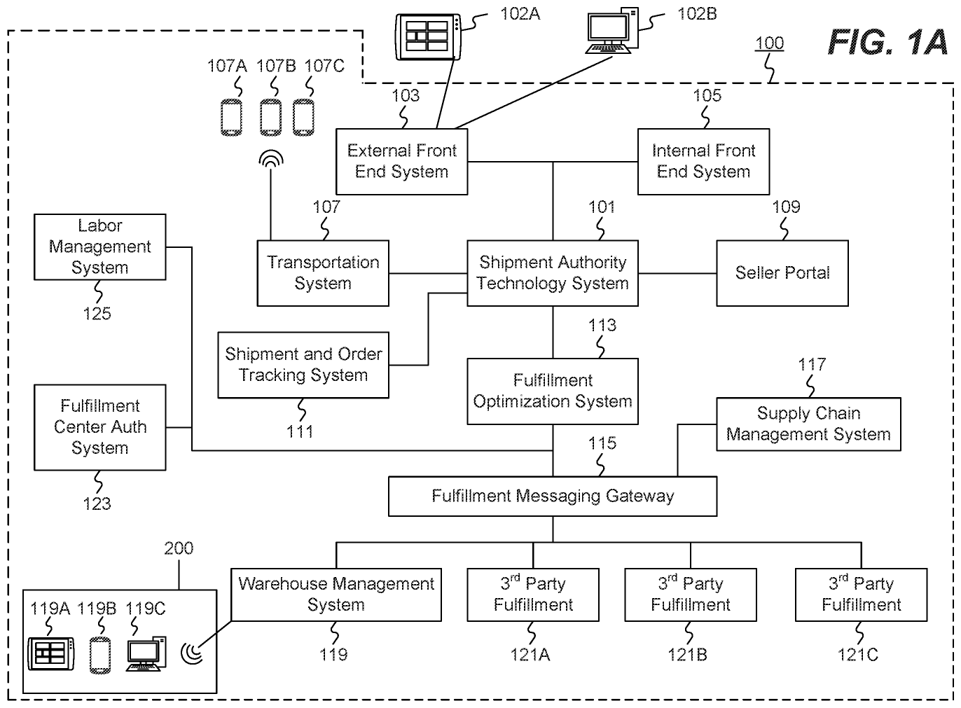

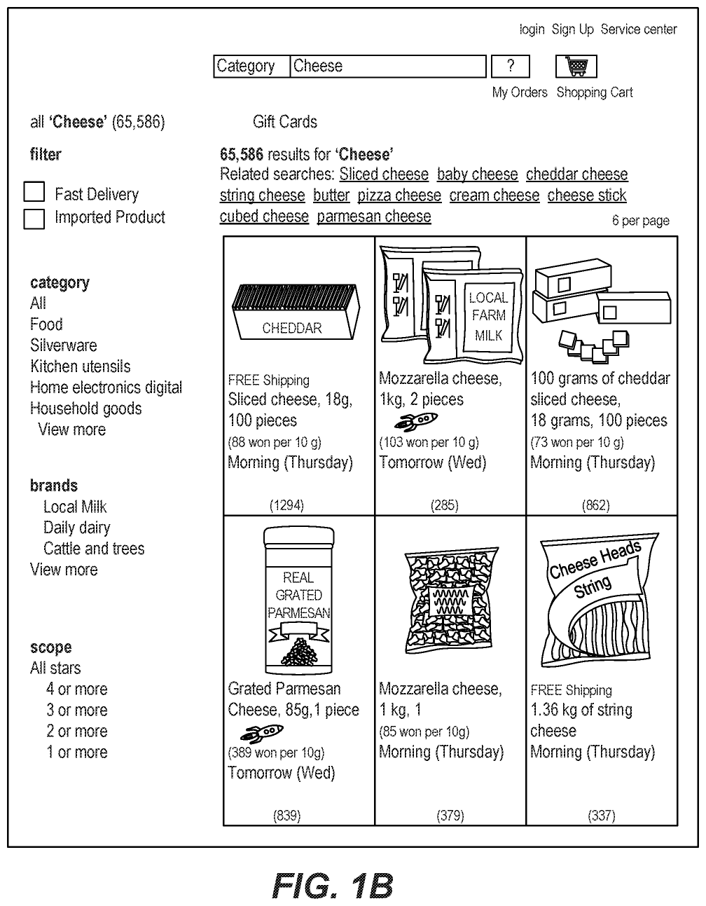

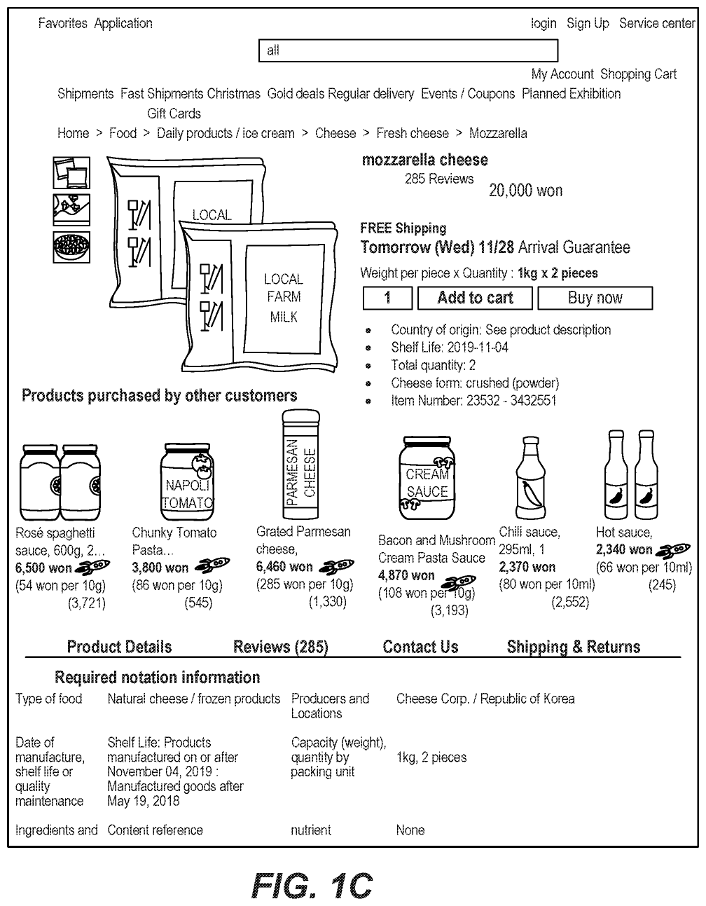

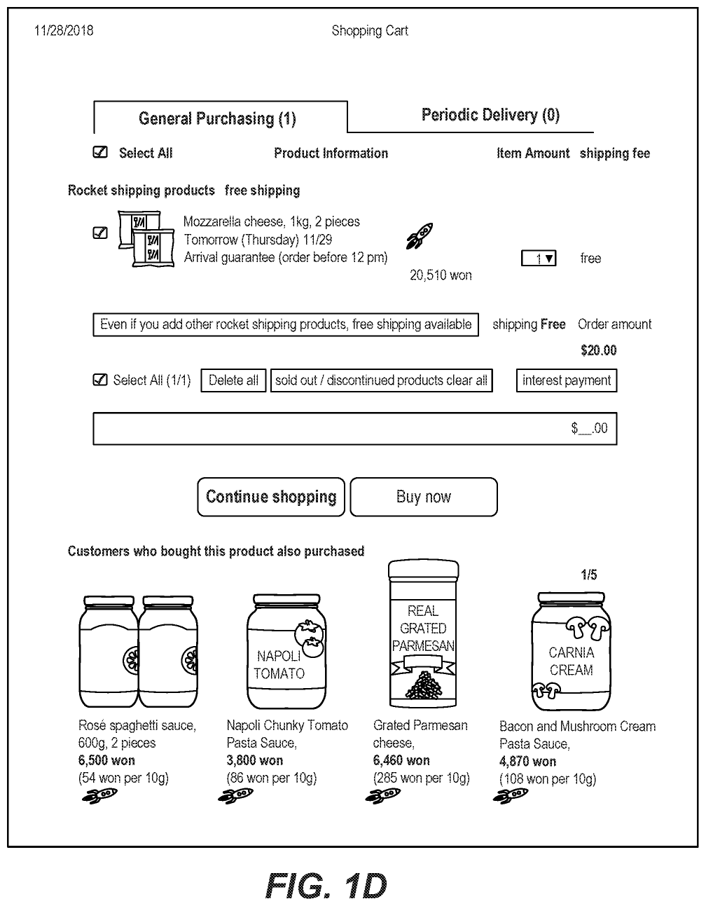

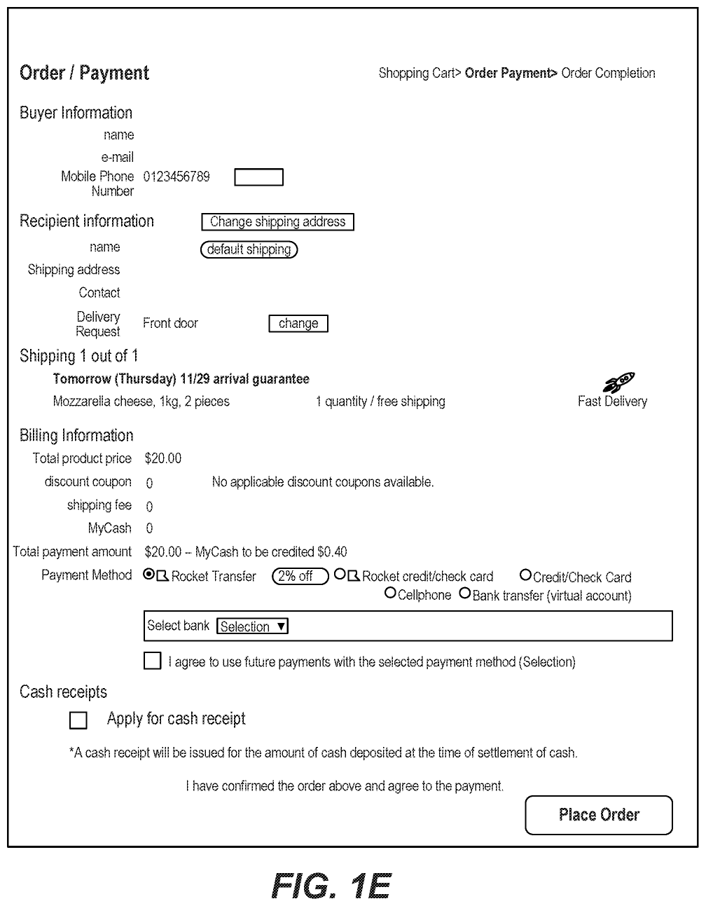

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3rd party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

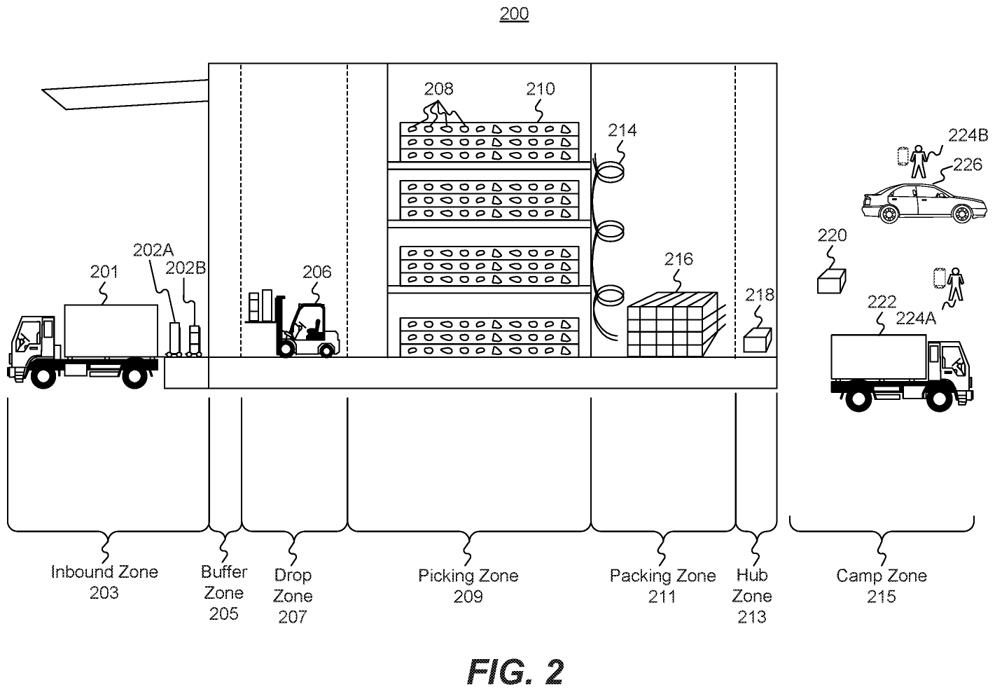

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 1198, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1198.

Once a user places an order, a picker may receive an instruction on device 1198 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

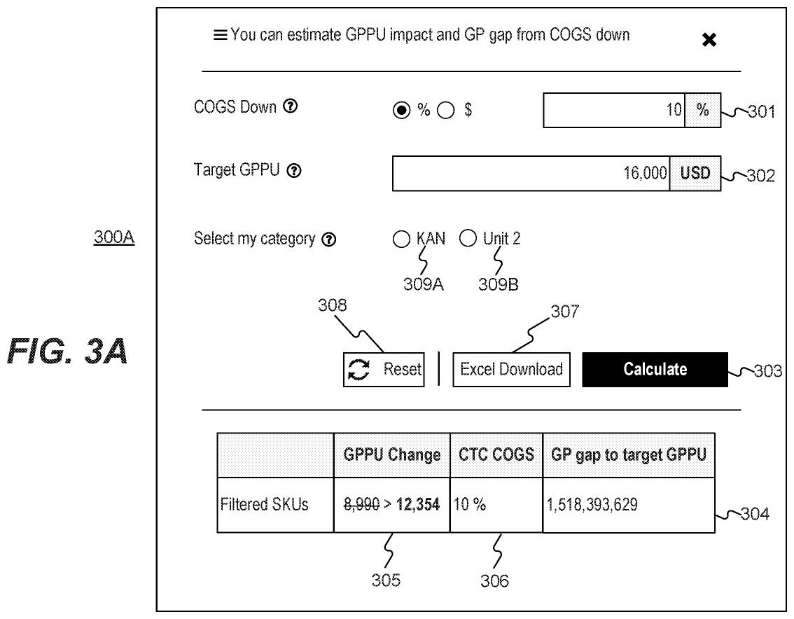

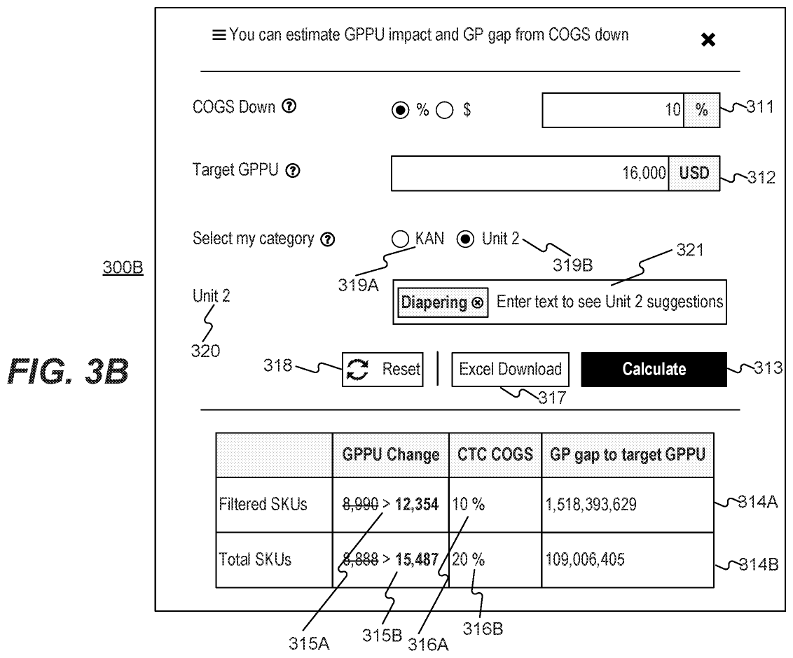

According to an aspect of the present disclosure, a user device may enable a user associated with the user device to interact with user interfaces depicted in FIGS. 3A-B to determine a gap to meet a goal for a set of products. The user may be responsible for ensuring that products, services, and product lines that fall under his/her domain resonate with current and potential customers. In order to achieve this goal, the user may continuously monitor marketing trends and keep a close eye on competitive products in the marketplace. The set of products may be associated with the user. For example, a set of products may comprise a particular seller (vendor) associated with products that fall under user's domain. The user may configure a user interface presented on a user device to select a particular seller. The user interface may present a list of sellers associated with the user to enable the user to select a particular seller among the presented list. When the set of products is selected, the user device may transmit the selected set of products to internal front end system 105, and internal front end system 105, upon receiving the set of products, may provide a user interface (e.g., user interface 300A in FIG. 3A) to enable the user device and the user to determine a gap to meet a goal (target) by reducing prices of products associated with the set of products and use the determined gap to meet the goal.

FIG. 3A depicts an exemplary user interface 300A for performing an automated calculation for determining a gap to meet a goal, consistent with disclosed embodiments. User interface 300A may include inputs 301 and 302, button 303, indicators 304-306, buttons 307 and 308, and selectable elements 309A-B. A user device may display user interface 300A on and a user associated with the user device may use the user device to interact with user interface 300A to determine the gap by configuring user interface 300A.

Input 301 may refer to a reduction per each unit associated with the set of products. In exemplary FIG. 3A, “COGS Down” means a reduced amount for cost of goods. The reduction can be provided in amount or percentage and can be used to calculate a reduced price. For example, a user may enter a reduction amount or percentage in input 301 on user interface 300A. If a reduction amount is $100, a reduced price for a product is a cost price minus $100. If a reduction percentage is 10%, a reduced price for a product is a cost price times 90% (100%−a reduction percentage). The cost price may refer to a price the user pays to a seller (vendor).

Input 302 may refer to a defined target (goal) by the user using user interface 300A. The defined target may comprise gross profit per unit (GPPU) and upon receiving a press, click, or other interaction by user interface 300A on button 303, the user device may transmit values entered in inputs 301 and 302 to internal front end system 105 to determine a gap to reach the target (input 302) by reducing prices by the reduction (input 301).

Internal front end system 105 may determine the gap by processing calculations. First, internal front end system 105 may determine a reduced price by reducing a cost price by reduced amount or percentage (input 301) received from the user device as described above with respect to input 301. Internal front end system 105 may communicate with seller portal 109 to retrieve the cost price associated with a product associated with the set of products. Second, internal front end system 105 may determine a pure product profit by subtracting the determined reduced price from a sales price, wherein the sales price can also be retrieved from seller portal 109. Third, internal front end system 105 may process the above calculations for each product in the set of products and aggregate calculated pure product profits. Internal front end system 105 may determine a gross profit by multiplying the target and a number of units (products) associated with the set of products. With the determined gross profit and the aggregated pure profits, internal front end system 105 may determine the requested gap by subtracting a pre-existing fund (funding data) captured from seller portal 109 and the aggregated pure profits from the determined gross profit.

Internal front end system 105 may also determine a change in GPPU by applying the reduction (input 301). The change in GPPU can be calculated by dividing the aggregated pure profits by the number of units (products) associated with the set of products.

Internal front end system 105, when the determined gap and the change in GPPU are determined, may update user interface 300A by displaying the determined gap on indicator 304, the change in GPPU on indicator 305, and a final reduction on indicator 306. The determined gap may provide a funding needed from a seller associated with the set of products to close the determined gap. The funding may comprise an advertisement funding, rebate funding, a coupon funding, etc. The user device can be configured to transmit a request to provide a fund to close the determined gap to a computing device of an entity (e.g., a seller or vendor) associated with the set of products. The change in GPPU may provide how much GPPU has increased by applying the reduction. The final reduction may correspond to the applied reduction (Input 301).

Buttons 307, upon receiving a press, click, or other interaction, may enable the user device to download data in indicators 304-306 in a spreadsheet. Button 308, upon receiving a press, click, or other interaction, may reset user interface 300A to enable the user to enter new inputs for inputs 301 and 302.

Selectable elements 309A-B may enable the user device to specify categories within the set of products. When the user selects one of selectable elements 309A-B, user interface 300A may be updated to user interface 300B in FIG. 3B to further specify products within the selected category, wherein the selected category refers to a subset of the set of products. For example, KAN and Unit 2 depicted in FIG. 3B refer to categories associated with the set of products. Using selectable elements 309A-B is discussed further below with respect to FIG. 3B. It is appreciated any number of selectable elements (categories) can be associated with the set of products.

FIG. 3B depicts an exemplary user interface 300B for performing an automated calculation for determining a gap to meet a goal and displaying the gap for a specified subset of products, consistent with disclosed embodiments. User interface 300B may include inputs 311 and 312, button 313, indicators 314-316, buttons 317 and 318, and selectable elements 319A-B. Inputs, buttons, indicators and elements included in user interface 300B can be similarly interacted to corresponding inputs, buttons, indicators, and elements in user interface 300A in FIG. 3A (e.g., inputs 311 and 312 can function to inputs 301 and 302 in FIG. 3A). Moreover, user interface 300B may display the determined gap on indicator 314A, the change in GPPU on indicator 315A, and a final reduction on indicator 316A similar to corresponding indicators 304-306 in FIG. 3A.

In addition to features described in FIG. 3A, user interface 300B can be further configured to specify a subset of products amongst a set of products and display a gap, a change in GPPU, and a final reduction for the specified subset. A user may determine the gap for the specified subset by configuring selectable elements 319A-B and input 321.

As explained above with respect to selectable elements 309A-B in FIG. 3A, the user may select one of selectable elements 319A-B to select a category amongst the set of products. Upon receiving a press, click, or other interaction on selectable elements 319A-B, the user device may transmit the selected category (e.g., Unit 2 in FIG. 3B) to internal front end system 105, and internal front end system, in response to the received selected category, may configure user interface 300B to update indicator 320 to display the selected category and provide a list of product suggestions in input 321. For example, if a user starts entering a text in input 321 (e.g., diapers in FIG. 3B), input 321 may provide product suggestions closely related to the entered text. When user interface 300B receives input 321 and upon receiving a press, click, or other interaction on button 313, the user device may transmit values entered in input 321 to internal front end system 105 to determine a required gap, a required reduction, and a change in GPPU for the specified subset to reach the target for the set of products by applying the reduction (input 311). The determination may comprise filtering out the specified group amongst the set of products.

Internal front end system 105, when the required gap, the change in GPPU, and the required reduction are determined, may update user interface 300 by displaying the required gap on indicator 314B, the change in GPPU on indicator 315B, and the required reduction on indicator 316B. The required gap may comprise an amount specified subset needs to make to meet the target amongst the set of products. The change in GPPU may provide a change in GPPU for the subset when the reduction (input 311) is applied to all products. The required reduction may provide a required reduction for the subset when the reduction (input 311) is applied to the set of products.

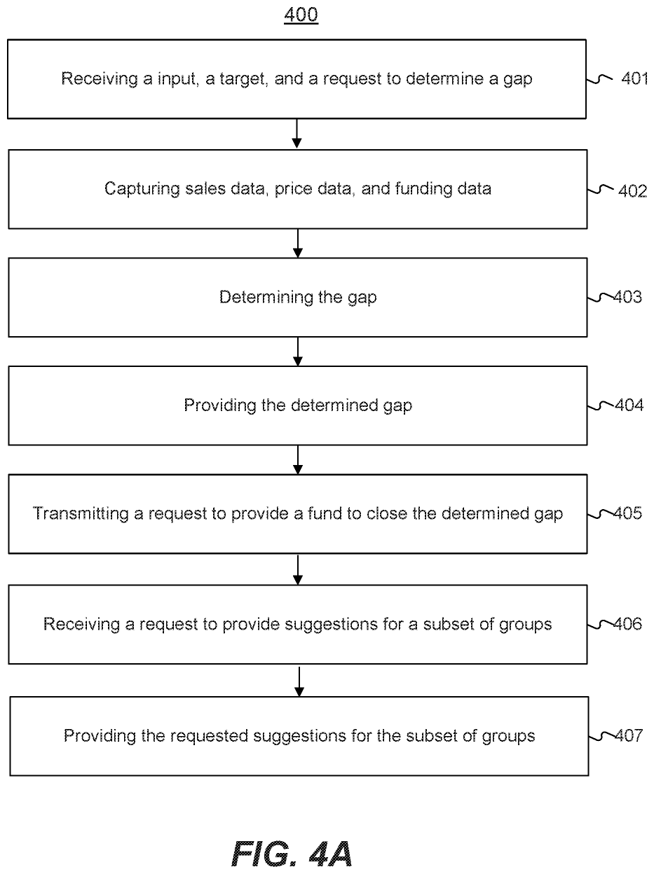

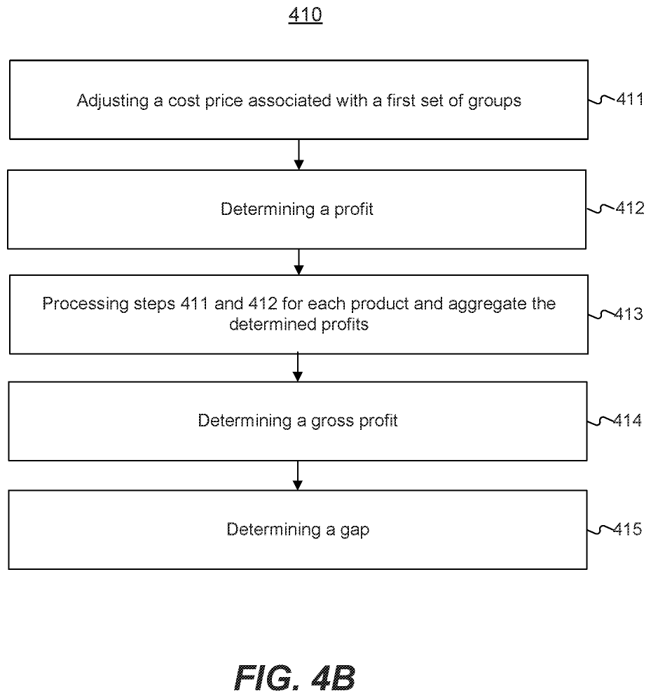

FIG. 4A is an exemplary flow chart of process 400 for performing an automated calculation for determining a gap to meet a goal for use with a user interface, consistent with the disclosed embodiments. This exemplary method is provided by way of example. Method 400 shown in FIG. 4A can be executed or otherwise performed by internal front end system 105. Method 400 as described below may be carried out by internal front end system 105 by way of example. Each block shown in FIG. 4A represents one or more processes, methods, or subroutines in the exemplary method 400. Referring to FIG. 4A, exemplary method 400 may begin at block 401.

In step 401, internal front end system 105 may receive, from a user device, an input, a target, and a request (e.g., inputs 301-302 and button 303 in FIG. 3A) to determine a gap to determine the target based on the input for a set of products. The user device may transmit the request when a user associated with the user device configures a user interface (e.g., user interface 300A in FIG. 3A) displayed on the user device. For example, a user device may provide a user interface presenting elements to enter a input, a target, and a set of products, and a user device may configure the user interface to request a gap to determine the target based on the input for the set of products. The request may be presented in the form of a button that the user device can receive a press, click, or other interaction on the button to request the gap.

In step 402, internal front end system 105 may capture sales data, price data, and funding data associated with the set of products from one or more systems storing data associated with the set of products. For example, internal front end system 105 may transmit a request to FO system 113 and/or seller portal 109 to provide sales data, price data, and funding data to internal front end system 105. The sales data may provide a sales price for each product associated with the set of products, the price data may provide a cost price for each product associated with the set of products, and the funding data may provide a pre-existing fund provided by a seller associated with the set of products.

In step 403, internal front end system 105 may determine a gap by applying the received input, the received target, the captured sales data, the captured price data, and the received funding data to a predefined formula. The predefined formula may comprise adjusting a cost price associated with the set of products and determining a profit. Each calculation incorporated in the predefined formula is further described below in FIG. 4B.

In step 404, internal front end system 105 may provide the determined gap to the user device. The determined gap may be provided in a user interface (user interface 300A in FIG. 3A) comprising an indicator (e.g., indicator 304 in FIG. 3A). Internal front end system 105 may, along with the determined gap, provide a change in GPPU and a final reduction in indicators (e.g., indicators 305 and 306 in FIG. 3A) implemented in the user interface (e.g., user interface 300A in FIG. 3A).

In step 405, internal front end system 105 may enable the user device to transmit a request to provide a fund to close the determined first gap to a computing device of an entity (seller) associated with the set of products. The request may comprise a message that additional funding such as advertisement funding, rebate funding, coupon funding, etc. is needed from the entity.

In step 406, internal front end system 105 may receive a request to provide suggestions for a second set of products. For example, a user device may configure a selectable element (e.g., selectable elements 319A or 319B) on user interface (e.g., user interface 300B in FIG. 3B) to submit a request for suggestions.

In step 407, internal front end system 105 may provide the requested suggestions for the subset of products in a user interface (e.g., user interface 300B). For example, internal front end system 105 may update an input (e.g., input 321 in FIG. 3B) incorporated in a user interface to provide a list of product suggestions. The provided list may enable a user to select a subset of the set of products and the selected subset may be transmitted, by the user device, to internal front end system 105 to determine a required gap, a required reduction, and a change in GPPU for the selected subset to reach the target for the set of products by applying the reduction. The determination may comprise filtering out data associated with the specified group amongst data associated with the set of products.

FIG. 4B is an exemplary flow chart of process 410 for processing a predefined formula to determine a gap, consistent with the disclosed embodiments. This exemplary method is provided by way of example. Method 410 shown in FIG. 4B can be executed or otherwise performed by internal front end system 105. Method 410 as described below may be carried out by internal front end system 105 by way of example. Each block shown in FIG. 4B represents one or more processes, methods, or subroutines in the exemplary method 410. Referring to FIG. 4B, exemplary method 410 may begin at block 411.

In step 411, internal front end system 105 may adjust a cost price associated with a set of products by reducing a cost price by a received input in step 401, the cost price being extracted from captured price data in step 402. Internal front end system 105 may determine the adjusted cost price by reducing a cost price by reduced amount or percentage (e.g., input 301 in FIG. 3A) received from a user device. Internal front end system 105 may communicate with seller portal 109 to retrieve the cost price associated with a product associated with a set of products.

In step 412, internal front end system 105 may determine a profit by subtracting the adjusted cost price from a sales price, the sales price being extracted from captured sales data in step 402. The sales data can be retrieved from seller portal 109.

In step 413, internal front end system 105 may process steps 411 and 412 for each product in the set of products and aggregate determined pure product profits. In step 414, internal front end system 105 may determine a gross profit by multiplying the received target from step 401 and a number of units (products) associated with the set of products. In step 415, internal front end system 105 may determine the requested gap by subtracting a pre-existing fund (funding data) captured from seller portal 109 and the aggregated pure profits from the determined gross profit.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

One or more memory devices may store data and instructions used to perform one or more features of the disclosed embodiments. For example, memory may represent a tangible and non-transitory computer-readable medium having stored therein computer programs, sets of instructions, code, or data to be executed by processor. Memory may include, for example, a removable memory chip (e.g., EPROM, RAM, ROM, DRAM, EEPROM, flash memory devices, or other volatile or non-volatile memory devices) or other removable storage units that allow instructions and data to be accessed by processor.

One or more memory devices may also include instructions that, when executed by processor, perform operations consistent with the functionalities disclosed herein. Devices consistent with disclosed embodiments are not limited to separate programs or computers configured to perform dedicated tasks. For example, memory may include one or more programs to perform one or more functions of the disclosed embodiments.

One or more processors may include one or more known processing devices, such as a microprocessor from the Pentium™ or Xeon™ family manufactured by Intel™, the Turion™ family manufactured by AMD™, the “Ax” or “Sx” family manufactured by Apple™, or any of various processors manufactured by Sun Microsystems. The disclosed embodiments are not limited to any type of processor(s).

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented system for determining one or more gaps to meet a target for use with a user device, comprising:
one or more memory devices storing instructions; and
one or more processors configured to execute the instructions to perform operations comprising:
receiving, from the user device, a first input, the target, and a first request to determine a first gap to meet the target based on the first input for a first set of groups;
capturing first sales data, first price data, and first funding data, including a first pre-existing fund, associated with the first set of groups from a system;
determining the first gap by utilizing the received first input, the received target, the captured first sales data, the captured first price data, and the captured first funding data;
providing the determined first gap to the user device; and
configuring the user device to allow the user device to transmit a request to an entity associated with the first set of groups to provide a first fund, in addition to the first pre-existing fund, to close the determined first gap.

2. The computer-implemented system of claim 1, wherein determining the first gap further comprises:
adjusting a cost price associated with the first set of groups by reducing the cost price by the received first input, the cost price being extracted from the captured first price data;
determining a profit by subtracting the adjusted cost price from a sales price, the sales price being extracted from the captured first sales data; and
determining the first gap by subtracting the determined profit and the first pre-existing fund from the received target.

3. The computer-implemented system of claim 2, wherein the operations further comprise providing an updated gross profit per unit, the updated gross profit per unit being determined by aggregating the determined profit and the determined first gap.

4. The computer-implemented system of claim 2, wherein the received first input is a percentage.

5. The computer-implemented system of claim 1, wherein the operations further comprise:
receiving a second set of groups and a second request to determine a second gap to meet the target based on the first input for the second set of groups, the second set of groups being a subset of the first set of groups;
filtering second sales data, second price data, and second funding data, including a second pre-existing fund, associated with the second set of groups from the captured first sales data, the captured first price data, and the captured first funding data;
determining the second gap by utilizing the received first input, the received target, the filtered second sales data, the filtered second price data, and the filtered second funding data;
providing the determined second gap to the user device; and
configuring the user device to allow the user device to transmit a request to an entity associated with the first set of groups to provide a second fund, in addition to the second pre-existing fund, to close the determined second gap.

6. The computer-implemented system of claim 5, wherein the determined first gap and the determined second gap are provided as a gross profit gap to the target, the target being a gross profit per unit.

7. (canceled)

8. The computer-implemented system of claim 1, wherein the system storing the first sales data, the first price data, and the first funding data comprises one or more subsystems.

9. The computer-implemented system of claim 1, wherein the operations further comprise:
receiving a request from the user device to provide suggestions for a second set of groups; and
providing the requested suggestions for the second set of groups to the user device.

10. The computer-implemented system of claim 9, wherein the operations further comprise providing the determined first gap and the determined second gap in a spreadsheet.

11. A computer-implemented method for determining one or more gaps to meet a target for use with a user device, comprising:
receiving, from the user device, a first input, the target, and a first request to determine a first gap to meet the target based on the first input for a first set of groups;
capturing first sales data, first price data, and first funding data, including a first pre-existing fund, associated with the first set of groups from a system;
determining the first gap by utilizing the received first input, the received target, the captured first sales data, the captured first price data, and the captured first funding data;
providing the determined first gap to the user device;
configuring the user device to allow the user device to transmit a request to an entity associated with the first set of groups to provide a first fund, in addition to the first pre-existing fund, to close the determined first gap.

12. The computer-implemented method of claim 11, wherein determining the first gap further comprises:
adjusting a cost price associated with the first set of groups by reducing the cost price by the received first input, the cost price being extracted from the captured first price data;
determining a profit by subtracting the adjusted cost price from a sales price, the sales price being extracted from the captured first sales data; and
determining the first gap by subtracting the determined profit and the first pre-existing fund from the received target.

13. The computer-implemented method of claim 12, further comprising providing an updated gross profit per unit, the updated gross profit per unit being determined by aggregating the determined profit and the determined first gap.

14. The computer-implemented method of claim 12, wherein the received first input is a percentage.

15. The computer-implemented method of claim 11, further comprising:
receiving a second set of groups and a second request to determine a second gap to meet the target based on the first input for the second set of groups, the second set of groups being a subset of the first set of groups;
filtering second sales data, second price data, and second funding data, including a second pre-existing fund, associated with the second set of groups from the captured first sales data, the captured first price data, and the captured first funding data;
determining the second gap by utilizing the received first input, the received target, the filtered second sales data, the filtered second price data, and the filtered second funding data;
providing the determined second gap to the user device; and
configuring the user device to allow the user device to transmit a request to an entity associated with the first set of groups to provide a second fund, in addition to the second pre-existing fund, to close the determined second gap.

16. The computer-implemented method of claim 15, wherein the determined first gap and the determined second gap are provided as a gross profit gap to the target, the target being a gross profit per unit.

17. The computer-implemented method of claim 11, wherein the system storing the first sales data, the first price data, and the first funding data comprises one or more subsystems.

18. The computer-implemented method of claim 11, further comprising:
receiving a request from the user device to provide suggestions for a second set of groups; and
providing the requested suggestions for the second set of groups to the user device.

19. The computer-implemented method of claim 18, further comprising providing the determined first gap and the determined second gap in a spreadsheet.

20. A computer-implemented system for determining one or more gaps to meet a target for use with a user device, comprising:
one or more memory devices storing instructions; and
one or more processors configured to execute the instructions to perform operations comprising:
receiving, from the user device, a first input, the target, and a first request to determine a first gap to meet the target based on the first input for a first set of groups;
capturing first sales data, first price data, and first funding data, including a first pre-existing fund, associated with the first set of groups from a system;
determining the first gap by utilizing the received first input, the received target, the captured first sales data, the captured first price data, and the captured first funding data;
providing the determined first gap and an updated gross profit per unit to the user device; and
configuring the user device to allow the user device to transmit a request to an entity associated with the first set of groups to provide a first fund, in addition to the first pre-existing fund, to close the determined first gap.

21. The computer-implemented method of claim 20, wherein determining the first gap further comprises:
adjusting a cost price associated with the first set of groups by reducing the cost price by the received first input, the cost price being extracted from the captured first price data;
determining a profit by subtracting the adjusted cost price from a sales price, the sales price being extracted from the captured first sales data; and
determining the first gap by subtracting the determined profit and the first pre-existing fund from the received target.
